(19) United States
(12) Patent Application Publication
(10) Pub. No.: US 2016/0314370 A1
(43) Pub. Date: Oct. 27, 2016

(54) METHOD AND APPARATUS FOR DETERMINATION OF OBJECT MEASUREMENTS BASED ON MEASUREMENT ASSUMPTION OF ONE OR MORE COMMON OBJECTS IN AN IMAGE

(71) Applicant: Nokia Technologies Oy, Espoo (FI)

(72) Inventors: Xin Chen, Evanston, IL (US); Xiaobai Liu, Los Angeles, CA (US); Chengcheng Yu, San Gabriel, CA (US); Song-Chun Zhu, Calabasas, CA (US)

(21) Appl. No.: 14/694,073

(22) Filed: Apr. 23, 2015

(51) Int. Cl. G06K 9/46; G06T 11/60; G06T 7/60; G06T 7/00; G06K 9/52

(52) U.S. Cl. CPC G06K 9/4604; G06T 7/0085; G06K 9/52; G06T 7/60; G06T 11/60; G06K 9/4671

(57) ABSTRACT

A method, apparatus and computer program product are provided for determination of object measurements based on measurement assumption of one or more common objects in an image. A method is provided including receiving an input image comprising at least a first object and a second object, detecting at least the first and second objects, constructing one or more measurement assumptions based on the first object, and determining, using a processor, one or more measurements of the second object based on the measurement assumptions.

### TECHNOLOGICAL FIELD

An example embodiment of the present invention relates to object measurement determinations of an image and, more particularly, to determination of object measurements based on measurement assumption of one or more common objects in an image.

### BACKGROUND

Several currently deployed user equipment (UE)s are equipped with high resolution red/green/blue (RGB) digital cameras which may be able to capture images or video of the environment surrounding a user. The UEs may be able to automatically determine and display or store, with the image, other data, such as location, time, or the like. However, determination of aspects within the image itself is limited or requires special calibration of the camera and/or UE.

### BRIEF SUMMARY

A method and apparatus are provided in accordance with an example embodiment for determination of object measurements based on measurement assumption of one or more objects in an image. In an example embodiment, a method is provided that includes receiving an input image comprising at least a first object and a second object, detecting at least the first and second objects, constructing one or more measurement assumptions based on the first object, and determining, using a processor, one or more measurements of the second object based on the one or more measurement assumptions.

In an example embodiment, the method also includes detecting straight line edges in the input image associated with the first or second object and the determining the one or more measurements of the second object is further based on the detected straight line edges. In some example embodiments, the method also includes parsing the input image into a three dimensional scene model and the constructing one or more measurement assumptions and the determining one or more measurements are based on the three dimensional scene model.

In an example embodiment of the method, the parsing the input image further comprises obtaining one or more camera parameters and the constructing one or more measurement assumptions and the determining one or more measurements are based on the one or more camera parameters. In some example embodiments, the method also includes receiving an indication of one or more measurements of interest and extracting the one or more measurement of interests from the one or more measurements of the second image.

In an example embodiment, the method also includes causing the one or more measurements of interest to be displayed on a user interface. In some example embodiments of the method, the constructing one or more measurement assumptions further comprises selecting a measurement assumption from a measurement assumption range based on a secondary factor.

In another example embodiment, an apparatus is provided including at least one processor and at least one memory including computer program code, with the at least one memory and computer program code configured to, with the processor, cause the apparatus to at least receive an input image comprising at least a first object and a second object, detect at least the first and second objects, construct one or more measurement assumptions based on the first object, and determine one or more measurements of the second object based on the measurement assumptions.

In some example embodiments of the apparatus, the at least one memory and the computer program code are further configured to detect straight line edges in the input image associated with the first or second object and the determining the one or more measurements of the second object is further based on the detected straight line edges. In an example embodiment of the apparatus, the at least one memory and the computer program code are further configured to parse the input image into a three dimensional scene model and the constructing one or more measurement assumptions and the determining one or more measurements are based on the three dimensional scene model.

In an example embodiment of the apparatus, the parsing the input image further comprises obtaining one or more camera parameters and the constructing one or more measurement assumptions and the determining one or more measurements are based on the one or more camera parameters. In some example embodiments of the apparatus, the at least one memory and the computer program code are further configured to receive an indication of one or more measurements of interest and extract the one or more measurements of interest from the one or more measurements of the second image.

In some example embodiments of the apparatus, the at least one memory and the computer program code are further configured to cause the extracted one or more measurements of interest to be displayed on a user interface. In an example embodiment of the apparatus, the constructing one or more measurement assumptions further comprises selecting a measurement assumption from a measurement assumption range based on a secondary factor.

In a further example embodiment, a computer program product is provided including at least one non-transitory computer-readable storage medium having computer-executable program code portions stored therein, with the computer-executable program code portions comprising program code instructions configured to receive an input image comprising at least a first object and a second object, detect at least the first and second objects, construct one or more measurement assumptions based on the first object, and determine one or more measurements of the second object based on the measurement assumptions.

In an example embodiment of the computer program product, the computer-executable program code portions further comprise program code instructions configured to detect straight line edges in the input image associated with the first or second object and the determining the one or more measurements of the second object is further based on the detected straight line edges. In some example embodiments of the computer program product, the computer-executable program code portions further comprise program code instructions configured to parse the input image into a three dimensional scene model and the constructing one or more measurement assumptions and the determining one or more measurements are based on the three dimensional scene model.

In some example embodiments of the computer program product, the parsing the input image further comprises obtaining one or more camera parameters and the constructing one or more measurement assumptions and the determining one or more measurements are based on the one or more camera parameters. In an example embodiment of the computer program product the computer-executable program code portions further comprise program code instructions configured to receive an indication of one or more measurements of interest and extract the one or more measurements of interest from the one or more measurements of the second image.

In an example embodiment of the computer program product, the computer-executable program code portions further comprise program code instructions configured to cause the extracted one or more measurements of interest to be displayed on a user interface. In some example embodiments of computer program product, the constructing one or more measurement assumptions further comprises selecting a measurement assumption from a measurement assumption range based on a secondary factor.

In yet a further example embodiment, an apparatus is provided including means for receiving an input image comprising at least a first object and a second object, means for detecting at least the first and second objects, means for constructing one or more measurement assumptions based on the first object, and means for determining one or more measurements of the second object based on the measurement assumptions.

In some example embodiments the apparatus also includes means for detecting straight line edges in the input image associated with the first or second object and the determining the one or more measurements of the second object is further based on the detected straight line edges. In an example embodiment, the apparatus also includes means for parsing the input image into a three dimensional scene model and the constructing one or more measurement assumptions and the determining one or more measurements are based on the three dimensional scene model.

In an example embodiment of the apparatus, the means for parsing the input image further comprises means for obtaining one or more camera parameters and the constructing one or more measurement assumptions and the determining one or more measurements are based on the one or more camera parameters. In some example embodiments, the apparatus also includes means for receiving an indication of one or more measurements of interest and means for extracting the one or more measurements of interest from the one or more measurements of the second image.

In some example embodiments, the apparatus also includes means for causing the extracted one or more measurements of interest to be displayed on a user interface. In an example embodiment, the means for constructing one or more measurement assumptions further comprises means for selecting a measurement assumption from a measurement assumption range based on a secondary factor.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 is a block diagram of an apparatus that may be specifically configured for determination of object measurements based on measurement assumptions of one or more common objects in an image in accordance with an example embodiment of the present invention;

FIG. 3 illustrates an example three dimensional scene model in accordance with an example embodiment of the present invention;

FIGS. 4 and 5 illustrate example user interface displays of the determined object of interest measurements in accordance with an example embodiment of the present invention; and

FIG. 6 illustrates an example process determination of object measurements based on measurement assumptions of one or more objects in an image in accordance with an embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

### Overview

Measurements of objects of interest in an image may be determined based on measurement assumptions of common objects which appear in the same image. Common objects, such as people, cars, or the like may be present in a majority of images captured by users. Additionally, these common objects may have a uniform measurement or measurement range, such as people may be 1.7-1.9 meters in height with an average of 1.8 meters and cars, such as sedans, may have a length of 4.4-5.2 meters with an average of 4.8 meters. The estimates or assumptions of the measurements of common objects in the image may be used to determine the measurements of objects of interest. A UE may utilize the measurement assumptions of the common objects in the image to simultaneously calibrate camera parameters and measure object dimensions. The measurement of the object of interest may be automatic, e.g. no user input is necessary and also does not need a specially designed calibration kit. Since the common objects may appear in both indoor and outdoor images, the determinations of object of interest measurements may also be performed, with high accuracy, both indoors and outside.

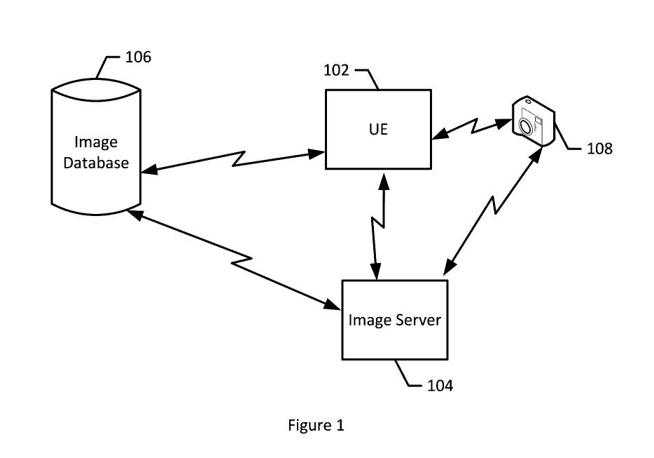

A method, apparatus and computer program product are provided in accordance with an example embodiment for determination of object measurements based on measurement assumptions of one or more common objects in an image. FIG. 1 illustrates a communication diagram including, an image server 104 in data communication with a user equipment (UE) 102, image database 106, and an image capture device 108. The communication between devices may be a wired, wireless, or any combination of wired and wireless communication networks, such as cellular, WiFi, internet, local area networks, or the like.

The UE 102 may be a mobile computing device such as a laptop computer, tablet computer, mobile phone, smart phone, navigation unit, personal data assistant, watch, camera, or the like. Additionally or alternatively, the UE 102 may be a fixed computing device, such as a personal computer, computer workstation, kiosk, office terminal computer or system, or the like. The image server 104 may be one or more fixed or mobile computing devices. The UE 102 and/or the image server 104 may be in data communication with or otherwise associated with an image capture device 108, e.g. camera.

The image capture device 108 may be a portion of the UE 102 or otherwise associated with the UE or image server 104. The image capture device 108 may be a fixed image camera, such as a RGB camera, a video camera, or the like capable of capturing one or more images. The images may be directly stored in the image server 104 or UE 102 or transmitted to the image server 104 for later processing.

The UE 102 or image server 104 may receive one or more images from the camera 108 or from the image database 106. The images may include one or more objects, such as buildings, streets, people, animals, or the like. The image may include at least a first object, e.g. a common object and a second object, e.g. the object of interest, such as a building or other structure. A common object may be an object with identifiable characteristics which is likely to appear in images captured by a user and which has been associated with a predetermined measurement assumption or predetermined measurement assumption range. An object of interest may be any object of which one or more edges may be determined.

The UE 102 or image server 104 may perform a camera calibration task and/or a three dimensional object measurement task using statistical inference, such as a unified Bayesian framework to preserve uncertainties during inference. A robust sampler, such as a Gibbs sampler, may be applied to the input image simulating a Markov Chain in a joint solution space. of the camera calibration task and the three dimensional object measurement task.

The UE 102 or image server 104 may apply an edge detector, such as Canny, thresholding, edge thinning, differential, phase congruency-based, or the like to the input image to detect edges in the image The UE 102 or image server 104 may apply feature detection, such as ridge detection to detect straight edges in the image. The straight lines may be grouped, by the UE 102 or the image server 104 into parallel families. The UE 102 or image server 104 may associate each parallel family with an object of interest. For example, the edges of a building face may be grouped into a parallel family.

The UE 102 or image server 104 may parse, or segment the image to generate a three dimensional scene model and determine camera parameters. In an example embodiment parsing the image may include extracting appearance, shape, or texture features, learning hierarchical representations for both foreground objects (e,g. car) and background structure (e,g. ground, building), and performing efficient composite inference over testing images. In an example embodiment an attributed grammar method may be employed to extract features. The attributed grammar method may extract features based on a set of production rules, similar to parsing a sentence into grammar elements.

The camera parameters may be a portion of the data associated with the input image, such as, location, time, focal length, height, or the like stored at the time of capture of the image. In some example embodiments, the camera parameters may be calculated based on the image and specifications associated with the camera. In an example embodiment, the camera parameters may be calculated based on the content of the input image.

In most images, such as city images, geometric regularities exist. Taking the city example, straight lines on the building are usually projections of families of parallel lines, and each family of lines shall merge at vanishing points in the imaging plane. These families are either orthogonal to each other, e.g. for the Manhattan type scenes, or orthogonal to the vertical gravity direction, e.g. for the Atlantic streets. The camera parameters may be calibrated by detecting straight edges in one or more images, grouping edges into vanishing points, and estimating focal length and/or other camera parameters based on the vanishing points. In an example embodiment integer programming may be used to exploit orthogonal conditions to render a faster convergence.

Additionally or alternatively, a repetitive pattern may be used to determine camera parameters. In a perspective projection, a pattern, such as two windows of the same dimension, may have different projected lengths in an image plane. Each pattern, if detected, may lead to a constraint equation for solving the desired camera parameters. Once a sufficient number of repetitive patterns are detected the UE 102 or image server 104 may solve for the camera parameters analytically, e.g. by a least square method.

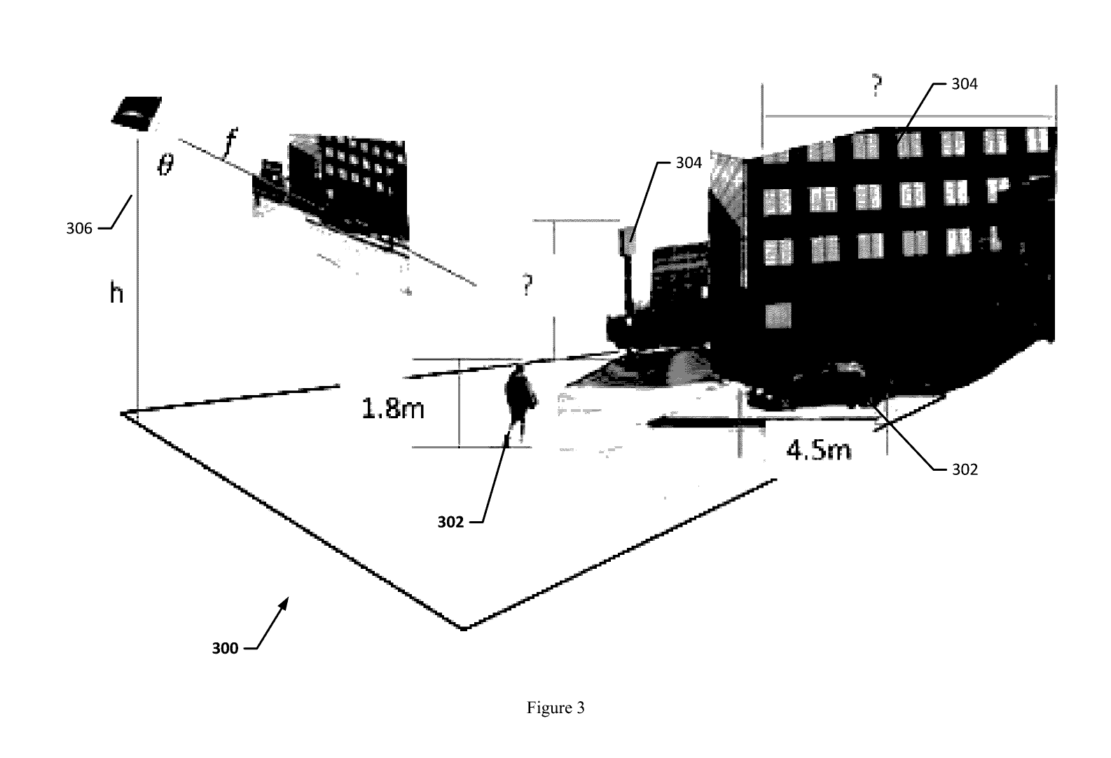

As illustrated in FIG. 3, the UE 102 or image server 104 has generated a three dimensional scene model including two common objects 302 a person and a car, and two objects of interest 304, a building and a street pole. The UE 102 or image server 104 has also detected camera parameters 306, h being the height of the camera, Θ being the compass or camera angle, and f being the focal length.

The UE 102 or image server 104 may construct one or more measurement assumptions based on the detected common objects, and/or repetitive patterns, such as windows in a building. As depicted in FIG. 3, The UE 102 has constructed a measurement assumption for each common object, 1.8 meters for the person and 4.5 meters for the car. In some example embodiments, the UE 102 or image server 104 may determine a common object based on object recognition, such as the object recognitions methods discussed above, and associate a predetermined measurement assumption with the common object. In an example embodiment, the UE 102 or the image server 104 may select a measurement assumption from a measurement range based on a secondary factor, for example image location, since person heights and car lengths may vary based on location.

The UE 102 or image server 104 may determine one or more measurements of the objects of interest in the image. As depicted in FIG. 3 the UE 102 or image server 104 has identified two measurements associated with objects of interest 304 to determine a measurement. The UE 102 or image server 104 may determine the measurements of the object of interest 304 based on the camera parameters 306, and the measurement assumptions. Since the height or length of a common object 302 is assumed, e.g. measurement assumptions, and the camera parameters 306 are known or calculated, the UE 102 or image server 104 may infer the height or length of the objects of interest. In an example embodiment the UE 102 or the image server 104 may use the camera parameters and at least one measurement assumption to scale the three dimensional scene model, e.g. absolute range. The UE 102 or image server 104 may determine the measurements for each detected object of interest 304 of the three dimensional scene model.

The UE 102 or image server 104 may cause a display of the image on a user interface. The user may select an “automatic” mode or a “manual” mode for measurement display.

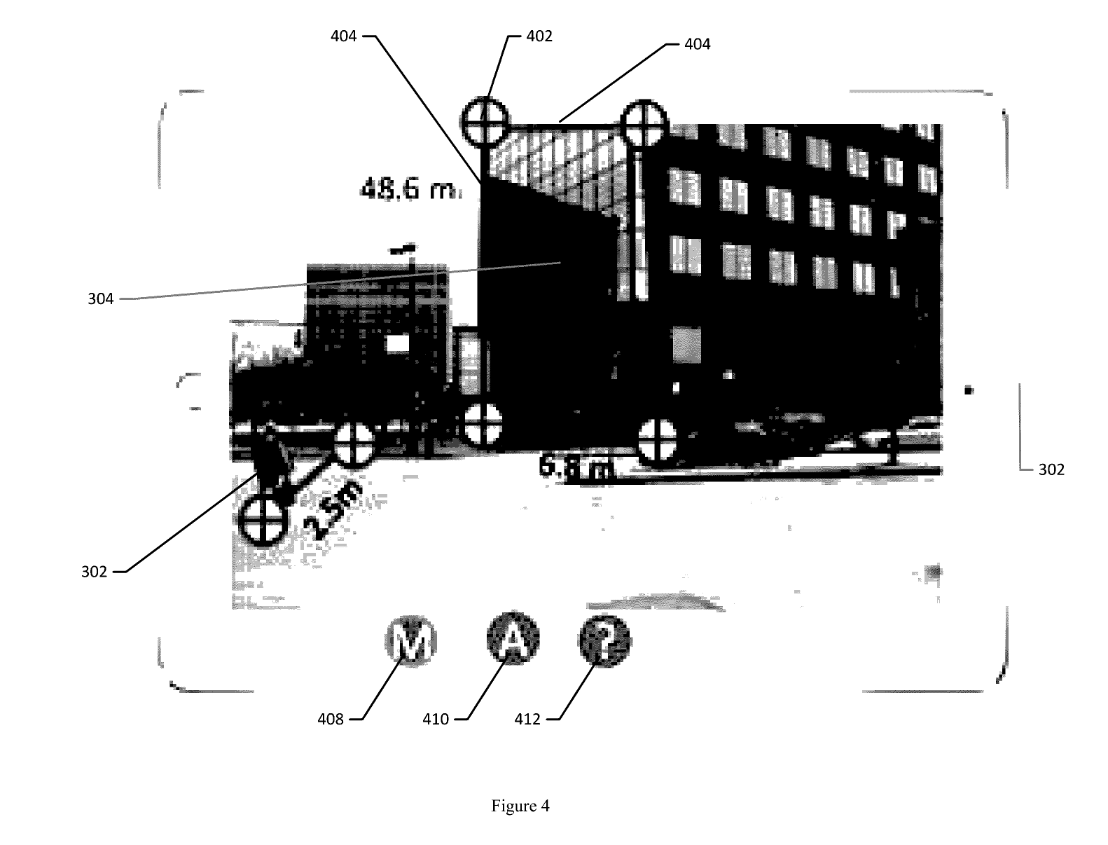

In FIG. 4 the manual mode is depicted. The UE 102 may detect one or more common objects 302 in the image, such as the person and the car. The UE 102 or image server 104 may also detect the repetitive pattern of the windows of a building. The UE 102 or image server 104 may also determine the camera parameters for determining one or more measurements of the objects of interest 304 in the image.

The user may select manual “M” 408 and select points 402, e.g. two, three, four, or more points, in the image, e.g. selecting an object of interest 304. The UE 102 or image server 104 may use the measurement assumptions of the common object 304 and/or camera parameters 306 to determine the measurements between the selected points 402. The UE 102 or image server 104 may extract one or more object of interest measurements from the three dimensional scene model 300. The UE 102 or image server 104 may cause the display of the measurement lines 404 between the points 402 and display the measurement. For example as depicted in FIG. 4, the user has selected the points 402 associated with the person's current position and the side of the street and the UE 102 or image server 104 has caused the display of the measurement line 404 and measurement of 2.5 meters. Additionally, the user has selected four points 402 indicating a face of a building 304. The UE 102 or image server 104 has caused the measurement lines 404 for the edges of the building face to be indicated and the measurements of 48.6 meters for the height of the building face and 6.8 meters for the width of the building face.

Additionally, or alternatively, the UE 102 or image server 104 may provide additional measurements, such as relative angle, rectangle sizes, e.g. area, polygonal sizes, or the like.

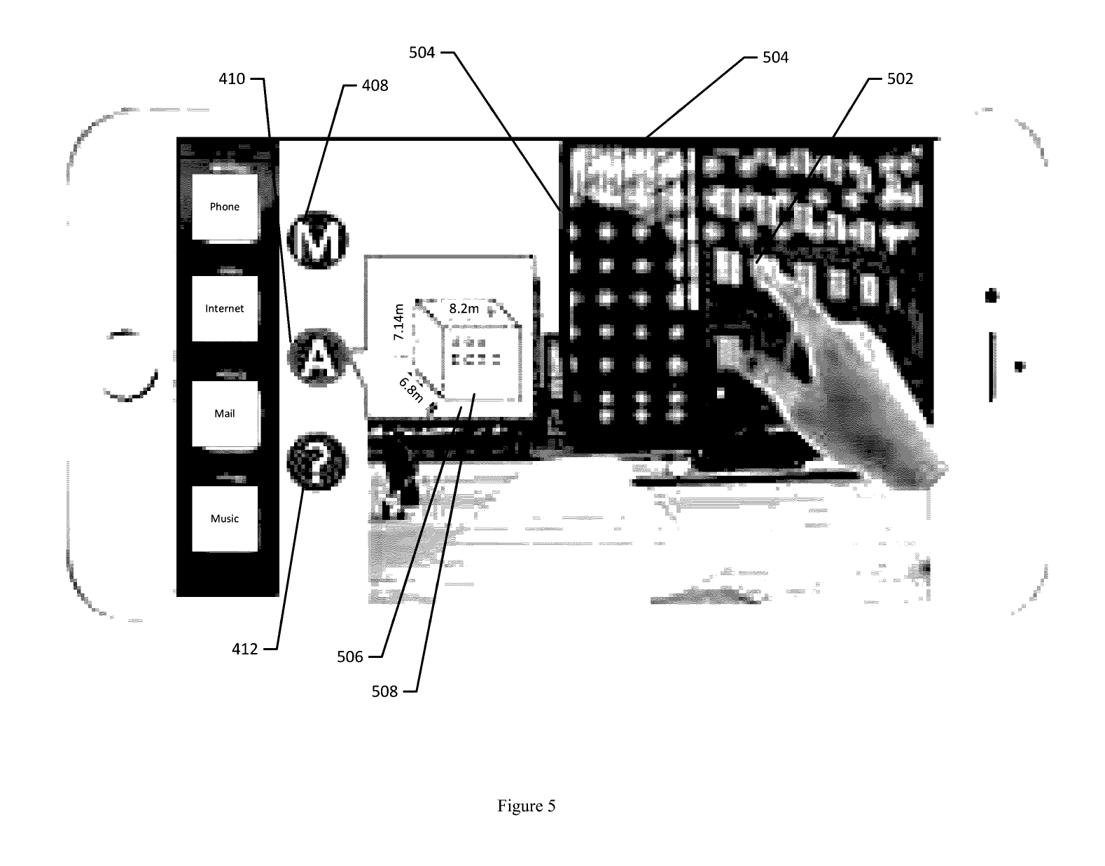

In FIG. 5 the automatic mode is depicted. The user may select automatic “A” 410 and touch a point on the image 502. The UE 102 or image server 104 may automatically determine the object of interest associated with the point touched 502, for example, as depicted in FIG. 5; the user has selected a point on a building face. The UE 102 or image server 104 may determine that the area of interest is the building. The UE 102 or image server 104 may extract the measurement associated with the object of interest from the three dimensional scene model 300. The UE 102 or image server 104 may cause the display of the edges of the object of interest, e.g. the edges of the building 504. In an example embodiment, the UE 102 or image server 104 may display the measurements in a separate depiction 506, such as a skeleton 508 of the object of interest with the associated measurements. In the depicted example of FIG. 5, the skeleton of the object of interest has a height of 7.14 meters, a width of 8.2 meters, and a depth of 6.8 meters. Additionally or alternatively, the measurements the object of interest may be depicted in proximity to the measurement lines 404 as shown in FIG. 4.

The user interface may also include a help icon “?” 412. The help icon 412 when selected may provide text, picture, or video tutorials on the use of the user interface.

### Example Apparatus

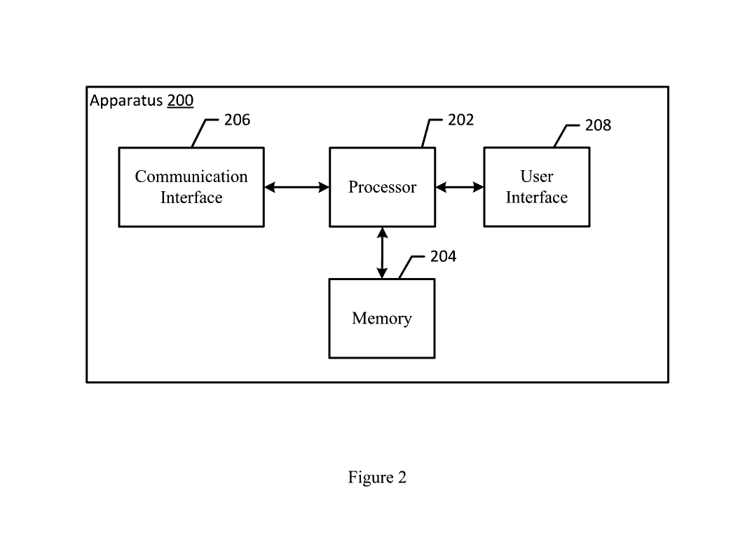

A UE 102 or image server 104 may include or otherwise be associated with an apparatus 200 as shown in FIG. 2. The apparatus, such as that shown in FIG. 2, is specifically configured in accordance with an example embodiment of the present invention for determination of object measurements based on a measurement assumption of one or more common objects in an image. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 200 may be embodied by a UE 102 or an image server 104. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data from/to a communications device in communication with the apparatus, such as to facilitate communications with one or more user equipment 104, utility device, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

### Example Process for Determination of Object Measurements Based on Measurement Assumption of One or More Common Objects in an Image

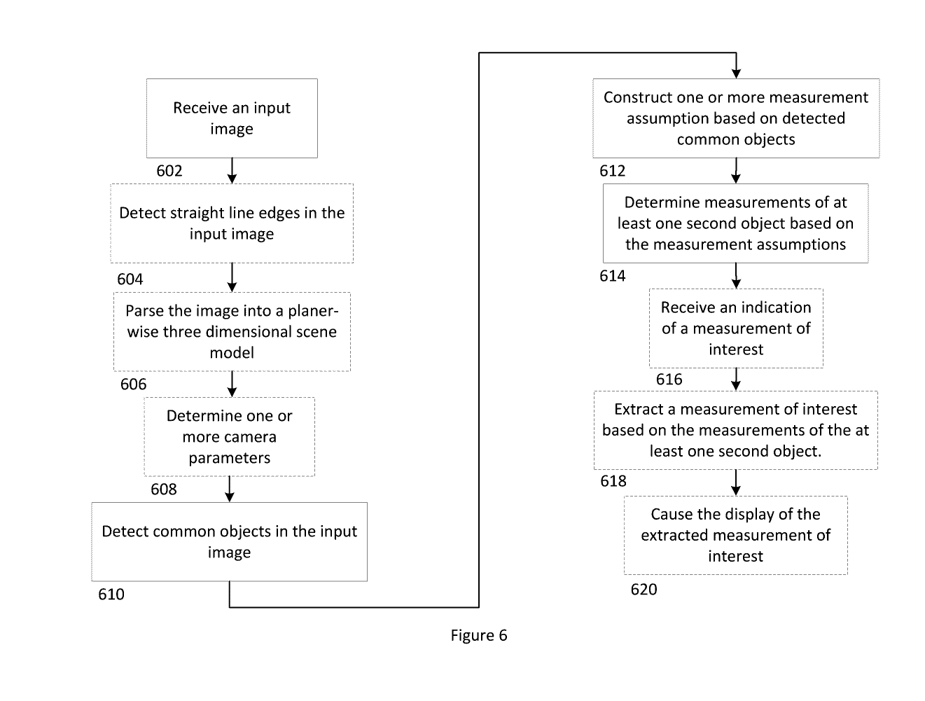

Referring now to FIG. 6, the operations performed, such as by the apparatus 200 of FIG. 2, for determination of object measurements based on measurement assumption of one or more common objects in an image are illustrated. As shown in block 602 of FIG. 6, the apparatus 200 may include means, such as a processor 202, memory 204, a communications interface 206, or the like, configured to receive an input image. The processor 202 may receive the input image from the communications interface 206, which may in turn receive the input image from a memory 204, such as an image database 106, or from an image capture device 108.

The image may include at least a first object, such as a common object and a second object, e.g. the object of interest, such as a building or other structure.

As shown in block 604 of FIG. 6, the apparatus 200 may include means, such as a processor 202, or the like, configured to detect straight line edges in the input images. The processor 202 may apply one or more edge detectors to the input image, such as Canny, thresholding, edge thinning, differential, phase congruency-based, or the like. The processor 202 may additionally apply one or more feature detectors, such as a ridge detector to the image to determine straight lines. The straight lines may be grouped, by the processor into parallel families.

As shown at block 606 of FIG. 6, the apparatus 200 may include means, such as a processor 202, or the like, configured to parse the input image into a three dimensional scene model. The processor 202 may parse, e.g. segment, the input image to generate a three dimensional scene model. In an example embodiment parsing the image may include applying object detection or object recognition, such as thresholding, clustering, compression based, histogram based, edge detection, dual clustering, region-growing, partial differential equation based, graph partitioning, watershed, model based multiscale, semi-automatic, trainable, or the like, to detect common objects and objects of interest in the input image.

As shown at block 608 of FIG. 6, the apparatus 200 may include means, such as a processor 202, or the like, configured to determine one or more camera parameters. The processor 202 may detect camera parameters, such a camera height, compass or camera angle, focal length, or the like. The camera parameters may be a portion of the data associated with the input image, such as, location, time, focal length, height, or the like stored at the time of capture of the input image. In some example embodiments, the camera parameters may be calculated based on the input image and specifications associated with the camera. In an example embodiment, the camera parameters may be calculated based on the content of input image.

As shown at block 610 of FIG. 6, the apparatus 200 may include means, such as a processor 202, or the like, configured to detect at least a first object, e.g. common object 302, and second object, e.g. object of interest 304, in the input image. The processor 202 may detect common objects 302, such as people, cars, or the like, and objects of interest 304, such as buildings, structures, street poles or the like. The processor 202 may detect the common objects based on object recognition, such as the methods discussed in block 606. The processor 202 may detect objects of interest based on edge detection, such as the methods discussed in block 606.

In an example embodiment, the processor 202 may apply an edge detector, as discussed at block 604, to the input image to detect edges in the image The processor 202 may also apply feature detection to detect straight edges in the image which may be grouped into parallel families. The processor 202 may associate each parallel family with an object of interest. For example, the edges of a building face may be grouped into a parallel family.

As shown at block 612 of FIG. 6, the apparatus 200 may include means, such as a processor 202, or the like, configured to construct one or more measurement assumption based on the common object 302. The processor 202 may determine measurement assumptions for each of the detected common objects 302. For example, the processor 202 may associate a predetermined measurement assumption to a common object 302 based on the type of object, such as a person may have a predetermined measurement assumption of 1.8 meters, and a car may have a predetermined measurement assumption of 4.5 meters.

Additionally or alternatively, the processor 202 may determine a measurement assumption, from a predetermined measurement assumption range, based on one or more secondary factors, such as location of the input image. For example, person heights and car lengths may vary based on location, in an instance in which the location indicates that the persons or car lengths in a given location are smaller than the average a measurement assumption may be selected from the low end of the predetermined measurement range.

As shown at block 614 of FIG. 6, the apparatus 200 may include means, such as a processor 202, or the like, configured to determine measurements of at least one second object, e.g. object of interest 304. The processor 202 may determine the measurements of the objects of interest 304 in the three dimensional scene model 300 based on the measurement assumptions of the common object 302 or objects. In some example embodiments, the processor 202 may further base the determination of measurements of the objects of interest 302 on the camera parameters 306 determined in block 608. In an example embodiment, the processor 202 may infer the measurements of the object of interest based on the three dimensional scene model 300, and/or camera parameters 306. Since the height or length of a common object 302 is assumed, e.g. measurement assumptions, and the camera parameters 306 are known or calculated, the processor 202 may infer the height or length of the objects of interest. In an example embodiment the processor 202 may use the camera parameters and at least one measurement assumption to scale the three dimensional scene model, e.g. absolute range. The processor 202 may determine the measurements for each detected object of interest 304 of the three dimensional scene model

As shown in block 616 of FIG. 6, the apparatus 200 may include means, such as a processor 202, user interface 208, or the like, configured to receive an indication of a measurement of interest. The processor 202 may receive an indication of a measurement of interest from the user interface 208. The user may select the mode for measurement display, such as manual or automatic.

In an instance in which manual mode is selected, the user may select a measurement of interest by points 402 on the image, such as two, three, four, or more points. The object of interest measurements may include straight line distance, relative angles, rectangular size, polygonal size, or the like.

In an instance in which automatic is selected, the user may select a measurement of interest by touch or select a point 502 of the image on the user interface 208. The processor 202 may determine an object of interest 504, and associated measurements of interest, associated with point 502.

As shown in block 618 of FIG. 6, the apparatus 200 may include means, such as a processor 202, or the like, configured to extract the measurement of interest from the measurements of the objects of interest. The processor 202 may extract the measurement of interest from the three dimensional scene model 300. The processor 202 may extract measurements of the objects of interest based on an indication of selected object of interest. The indication of a selected object of interest may be received from the user interface 208. The selection of the object of interest, in an automatic mode may be a selection of any portion of an object within the image which has been identified as an object of interest. The selection of an object of interest, in manual mode may be selection of two or more point 402 associated with an identified object of interest.

As shown in block 620 of FIG. 6, the apparatus 200 may include means, such as a processor 202, user interface 208, or the like, configured to cause the measurement of interest to be displayed on the user interface. In an instance in which the user selected manual mode, the processor 202 may cause the user interface 208 to display the points 402, measurement lines 404, and measurements. The object of interest 304 measurements may include straight line distance, relative angles, rectangular size, polygonal size, or the like. In an instance in which the user selected automatic mode, the processor 202 may depict the lines 504 associated with the object of interest, such as overlaid on the input image, in a separate display area 506, or the like. The processor 202 may cause the display of the measurements in association with the measurement lines 504.

The determination of measurements of objects of interest in an image based on common objects within the image, allows for a hands free automatic determine of the measurements within the image, without specially designed calibration kits. The measurement assumptions of the common objects may allow for simultaneous calibration or determination of camera parameters, and measurement of the objects of interest in a three dimensional scene model. Since common objects may appear in both indoor and outdoor images the described method may be applied to input images depicting either indoor or outdoor scenes.

As described above, FIG. 6 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of blocks 604-608 and 616-620 in FIG. 6. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving an input image comprising at least a first object and a second object;
detecting at least the first and second objects;
constructing one or more measurement assumptions based on the first object; and
determining, using a processor, one or more measurements of the second object based on the measurement assumptions.

2. The method of claim 1 further comprising:
detecting straight line edges in the input image associated with the first or second object, and
wherein the determining the one or more measurements of the second object is further based on the detected straight line edges.

3. The method claim 1 further comprising:
parsing the input image into a three dimensional scene model, and
wherein the constructing one or more measurement assumptions and the determining one or more measurements are based on the three dimensional scene model.

4. The method of claim 3, wherein the parsing the input image further comprises obtaining one or more camera parameters, and
wherein the constructing one or more measurement assumptions and the determining one or more measurements are based on the one or more camera parameters.

5. The method of claim 1 further comprising:
receiving an indication of one or more measurements of interest; and
extracting the one or more measurements of interest from the one or more measurements of the second image.

6. The method of claim 5 further comprising:
causing the extracted one or more measurements of interest to be displayed on a user interface.

7. The method of claim 1, wherein the constructing one or more measurement assumptions further comprises selecting a measurement assumption from a measurement assumption range based on a secondary factor.

8. An apparatus comprising at least one processor and at least one memory including computer program code, the at least one memory and computer program code configured to, with the processor, cause the apparatus to at least:
receive an input image comprising at least a first object and a second object;
detect at least the first and second objects;
construct one or more measurement assumptions based on the first object; and
determine one or more measurements of the second object based on the measurement assumptions.

9. The apparatus of claim 8, wherein the at least one memory and the computer program code are further configured to:
detect straight line edges in the input image associated with the first or second object, and
wherein the determining the one or more measurements of the second object is further based on the detected straight line edges.

10. The apparatus of claim 8, wherein the at least one memory and the computer program code are further configured to:
parse the input image into a three dimensional scene model, and
wherein the constructing one or more measurement assumptions and the determining one or more measurements are based on the three dimensional scene model.

11. The apparatus of claim 10, wherein the parsing the input image further comprises obtaining one or more camera parameters, and
wherein the constructing one or more measurement assumptions and the determining one or more measurements are based on the one or more camera parameters.

12. The apparatus of claim 8, wherein the at least one memory and the computer program code are further configured to:
receive an indication of one or more measurements of interest; and
extract the one or more measurements of interest from the one or more measurements of the second image.

13. The apparatus of claim 12, wherein the at least one memory and the computer program code are further configured to:
cause the extracted one or more measurements of interest to be displayed on a user interface.

14. The apparatus of claim 8, wherein the constructing one or more measurement assumptions further comprises selecting a measurement assumption from a measurement assumption range based on a secondary factor.

15. A computer program product comprising at least one non-transitory computer-readable storage medium having computer-executable program code portions stored therein, the computer-executable program code portions comprising program code instructions configured to:
receive an input image comprising at least a first object and a second object;
detect at least the first and second objects;
construct one or more measurement assumptions based on the first object; and
determine one or more measurements of the second object based on the measurement assumptions.

16. The computer program product of claim 15, wherein the computer-executable program code portions further comprise program code instructions configured to:
detect straight line edges in the input image associated with the first or second object, and
wherein the determining the one or more measurements of the second object is further based on the detected straight line edges.

17. The computer program product of claim 15, wherein the computer-executable program code portions further comprise program code instructions configured to:
parse the input image into a three dimensional scene model, and
wherein the constructing one or more measurement assumptions and the determining one or more measurements are based on the three dimensional scene model.

18. The computer program product of claim 17, wherein the parsing the input image further comprises obtaining one or more camera parameters, and
wherein the constructing one or more measurement assumptions and the determining one or more measurements are based on the one or more camera parameters.

19. The computer program product of claim 15, wherein the computer-executable program code portions further comprise program code instructions configured to:
receive an indication of one or more measurements of interest; and
extract the one or more measurements of interest from the one or more measurements of the second image.

20. The computer program product of claim 19, wherein the computer-executable program code portions further comprise program code instructions configured to:
cause the extracted one or more measurements of interest to be displayed on a user interface.

21-28. (canceled)
